(19) United States
(12) Patent Application Publication
(10) Pub. No.: US 2012/0221668 A1
(43) Pub. Date: Aug. 30, 2012

(54) CLOUD STORAGE ACCESS DEVICE AND METHOD FOR USING THE SAME

(75) Inventors: BIN-RONG CHEN, Tu-Cheng (TW); CHIEN-PAN LAI, Tu-Cheng (TW); CHIH-YUAN HUANG, Tu-Cheng (TW)

(73) Assignee: HON HAI PRECISION INDUSTRY CO., LTD., Tu-Cheng (TW)

(21) Appl. No.: 13/080,670

(22) Filed: Apr. 6, 2011

(30) Foreign Application Priority Data
Feb. 25, 2011 (CN) 201110045674.X

(51) Int. Cl. G06F 15/167

(52) U.S. Cl. 709/212

(57) ABSTRACT

A cloud storage access device includes a data fetching unit, a user management unit, and a data link unit. The data fetching unit collects private data of each user of the cloud storage access device. The user management unit creates a home directory corresponding to each user in the cloud storage access device. The data link unit connects each of the home directories to both the cloud and a local storage of a network terminal, such that the cloud storage access device communicates with both the cloud and the local storage. Each user of the cloud storage access device stores data to the cloud or the local storage and accesses data stored in the cloud or the local storage through the home directory corresponding to the user.

### BACKGROUND

1. Technical Field

The present disclosure relates to data storage access devices, and particularly to a cloud storage access device and a method for using the same.

2. Description of Related Art

With the development of cloud storage technology, much data is stored in the cloud-based storage (“cloud storage”). Most typical network terminals, such as personal computers (PC) connected to Internet, can only directly store data to their local storage and access data stored in the local storage, and are unable to directly store data to the cloud storage and access data stored in the cloud storage. When these network terminals need to store data to the cloud storage or access data stored in the cloud storage, they are connected to the cloud by special cloud storage access devices and communicate with the cloud storage through the cloud storage access devices. However, the cloud may include different kinds of cloud storage, and each kind of cloud storage may be only compatible with one special kind of cloud storage access devices. Thus, a network terminal may need to be simultaneously connected to the cloud by different kinds of cloud storage access devices to ensure that the network terminal is capable of storing data to different kinds of cloud storage of the cloud and accessing data stored in the different kinds of cloud storage.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of a cloud storage access device, according to an exemplary embodiment.

FIG. 2 is a schematic diagram of data connections generated between a cloud and a local storage of a network terminal connected to the cloud by the cloud storage access device shown in FIG. 1.

FIG. 3 is a flowchart of a method for using the cloud storage access device shown in FIG. 1.

### DETAILED DESCRIPTION

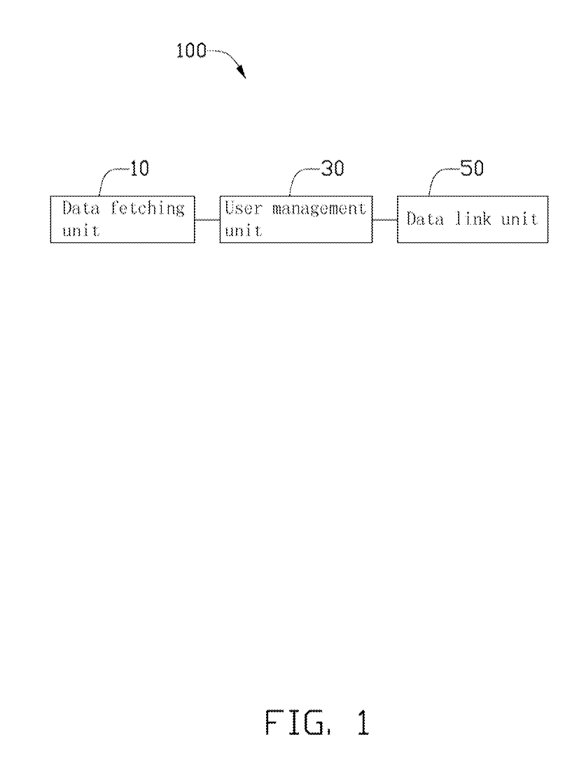

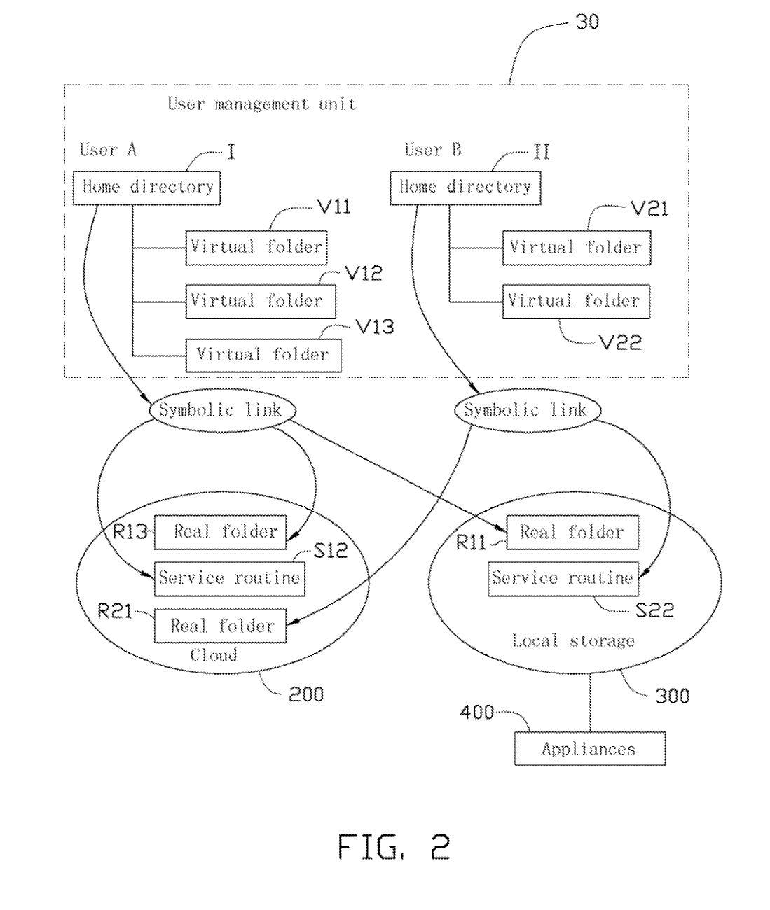

FIG. 1 shows a block diagram of a cloud storage access device 100, according to an exemplary embodiment. The cloud storage access device 100 can be used to connect a network terminal, such as a personal computer (PC), mobile phone, or personal digital assistant (PDA), to a cloud 200, thereby enabling the cloud 200 and the network terminal to store and access data stored in each other local storage systems. Also referring to FIG. 2, the cloud storage access device 100 can store data to the cloud 200 and a local storage 300 of the network terminal, and access data stored in the cloud 200 and the local storage 300. In this embodiment, the local storage 300 can be a conventional storage device of the network terminal, such as a hard disk or a memory card. The cloud storage access device 100 is connected to both the cloud 200 and the local storage 300 using typical means, such as Universal Serial Bus (USB).

The cloud storage access device 100 includes a data fetching unit 10, a user management unit 30, and a data link unit 50 connected in series. In general, the word “unit”, as used herein, refers to logic embodied in hardware or firmware, or to a collection of software instructions, written in a programming language, such as, Java, C, or Assembly. One or more software instructions in the units may be embedded in firmware, such as EPROM. The units described herein may be implemented as either software and/or hardware units and may be stored in any type of computer-readable medium or other storage device.

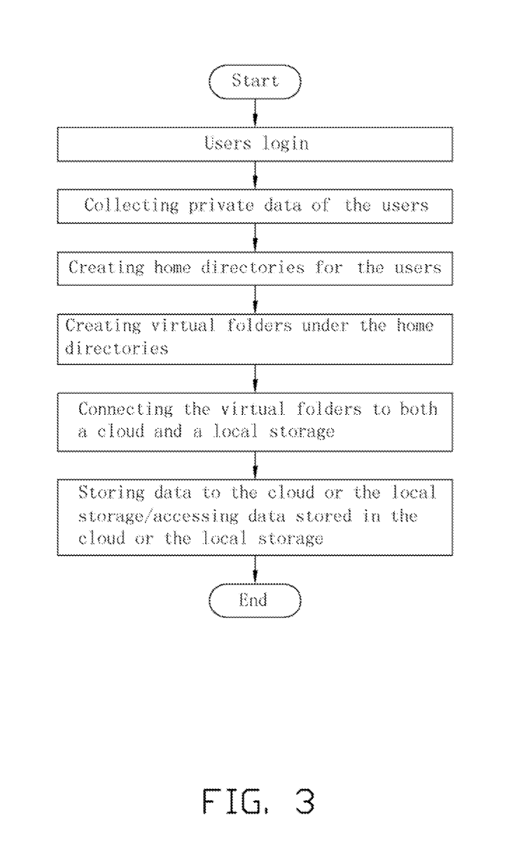

FIG. 3 shows a flowchart of a method for using the cloud storage access device 100. First, users of the cloud storage access device 100 login to the cloud storage access device 100, and the data fetching unit 10 collects relative private data of the users.

In this embodiment, the relative private data includes at least the identities (ID) of the users, Internet protocol (IP) addresses of the users, and other application protocols that are to be used by the users, such as Digital Living Network Alliance (DLNA), Samba service for Linux systems, and File Transfer Protocol (FTP).

The private data of the users collected by the data fetching unit 10 is transmitted to the user management unit 30. Upon receiving the private data of the users, the user management unit 30 creates home directories corresponding to each of the users therein, such that each user has at least one home directory created by the user management unit 30. Additionally, the user management unit 30 can also create the home directories in other common storage systems of the cloud storage access device, such as a hard disk drive. For identifying the home directories, addresses of all the home directories can be allocated corresponding to any kind of the private data of the users. Also referring to FIG. 2, in this embodiment, the user management unit 30 creates two home directories I, II, which respectively correspond to two users A, B of the cloud storage access device 100. The addresses of the home directories I, II can be allocated respectively corresponding to the ID of the two users A, B, or respectively corresponding to the IP addresses of the two users A, B, or respectively corresponding to the kinds of the application protocols that are to be used by the two users A, B.

The data link unit 50 connects each of the home directories to both the cloud 200 and the local storage 300 by means of symbolic link(s), such that the cloud storage access device 100 can communicate with both the cloud 200 and the local storage 300. Thus, each user can store data to the cloud 200 or the local storage 300 and access data stored in the cloud 200 or the local storage 300 using the home directory corresponding to the user. Furthermore, the cloud 200 can also communicate with the local storage 300 through each of all the home directories, such that the cloud 100 can be used to process data stored in the local storage 300, and common appliances 400 (e.g., image capturing modules, printers, and audio communication devices) connected to the local storage 300 can also be used to process data stored in the cloud 200. In this embodiment, under each home directory, the user management unit 30 creates at least two virtual folders. The data link unit 50 connects at least one of the virtual folders to the local storage 300 and the other of the virtual folders to the cloud 200 by means of the symbolic link(s).

Each of the virtual folders is connected to a real folder or a service routine created in the cloud 200 or the local storage 300 by means of symbolic link(s) to enable operations in the virtual folders to be applied to the cloud 200 or the local storage 300. The real folders can be common cloud storage of the cloud 200, and can also be folders corresponding to common appliances 400 connected to the local storage 300, such as a hard disk, a flash, a built-in motion eye, or a speaker. The service routine can be service routines processed by the cloud 200, such as a translation routine, a file mode converting routine, or an image processing routine; and can also be service routines processed by the appliances 400 connected to the local storage 300, such as an image capturing routine, a print routine or an audio signal code/encode routine.

Also referring to FIG. 2, in this embodiment, the user management unit 30 creates three virtual folders V11, V12, V13 under the home directory I, and creates two virtual folders V21, V22 under the home directory II. By means of the symbolic link(s), the virtual folder V11 is connected to a real folder R11 of the local storage 300, the virtual folder V12 is connected to a service routine S12 of the cloud 200, the virtual folder V13 is connected to another real folder R13 of the cloud 200, the virtual folder V21 is connected to a real folder R21 of the network cloud 200, and the virtual folder V22 is connected to a service routine S22 of the local storage 300. Thus, the user A can store data to the local storage 300 and access data stored in the local storage 300 (i.e., store and access local data) using the virtual folder V11 and the real folder R11, store data to the cloud 200 and access data stored in the cloud 200 using the virtual folder V13 and the real folder R13, and operate processors (not shown) of the cloud 200 to process data stored in the local storage 300 (i.e., in the real folder R11) or the cloud 200 (i.e., in the real folder R13) using the virtual folder V12 and the service routine S12. For example, if the service routine S12 is a file mode converting routine, the user A can operate processors of the cloud 200 to convert file modes of data stored in the real folder R11/R13. The user B can store data to the cloud 200 and access data stored in the cloud 200 using the virtual folder V21 and the real folder R21, and operate the appliances 400 connected to the local storage 300 to process data stored in the cloud 200 (i.e., in the real folder R21) using the virtual folder V22 and the service routine S22. For example, if the service routine S22 is a print routine, the user B can operate a printer of the appliances 400 connected to the local storage 300 to print data stored in the real folder R21.

As above detailed, network terminals using the cloud storage access device 100 are enabled to store data to the local storage 300 and most common cloud storage of the cloud 200, and access data stored in the local storage 300 and the cloud storage in the cloud 200. Network terminals with the cloud storage access device 100 can also be used to operate the cloud 200 to process data stored in the local storage 300, and operate the appliances 400 connected to the local storage 300 to process data stored in the cloud 200. According to above detailed method for enabling the could 200 and the local storage 300 to store data to each other and access data stored in each other, the cloud storage access device 100 can be compatible with most common cloud storage of the cloud 200. The cloud storage access device 100 can replace different kinds of conventional cloud storage access devices for respectively connecting the network terminals to different kinds of cloud storage, thereby simplifying operations for using the network terminals.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A cloud storage access device, comprising:
a data fetching unit that collects private data of each user of the cloud storage access device;
a user management unit that creates a home directory corresponding to each user of the cloud storage access device in a storage system of the cloud storage access device; and
a data link unit that connects each of the home directories to both a cloud and a local storage of a network terminal, such that the cloud storage access device communicates with both the cloud and the local storage, and each user of the cloud storage access device stores data to the cloud or the local storage and accesses data stored in the cloud or the local storage through the home directory corresponding to the user.

2. The cloud storage access device as claimed in claim 1, wherein the cloud communicates with the local storage through each of all the home directories, such that the cloud processes data stored in the local storage, and appliances connected to the local storage process data stored in the cloud.

3. The cloud storage access device as claimed in claim 1, wherein the data link unit connects each of the home directories to both the local storage and the cloud by means of symbolic link.

4. The cloud storage access device as claimed in claim 3, wherein the user management unit creates at least two virtual holders under each of the home directories, and the data link unit connects at least one of the virtual folders to the local storage and the other of the virtual folders to the cloud.

5. The cloud storage access device as claimed in claim 4, wherein each of the virtual folders is connected to a real folder or a service routine created in the cloud or the local storage to enable operations in the virtual folders to be applied to the cloud or the local storage.

6. The cloud storage access device as claimed in claim 5, wherein the real folders of the cloud are cloud storage of the cloud, and the real folders of the local storage are folders corresponding to the appliances connected to the local storage.

7. The cloud storage access device as claimed in claim 5, wherein the service routines of the cloud are translation routines, file mode converting routines, or image processing routines processed by the cloud; and the service routines of the local storage are image capturing routines, print routines, or audio signal code/encode routines processed by the appliances connected to the local storage.

8. The cloud storage access device as claimed in claim 1, wherein addresses of all the home directories are allocated corresponding to the private data of the users, the private data of the users including identity (ID) of each user, Internet protocol (IP) address of each user, and application protocols that are to be used by each user.

9. The cloud storage access device as claimed in claim 8, wherein the application protocols that are to be used by each user includes Digital Living Network Alliance (DLNA), Samba service for Linux systems, and File Transfer Protocol (FTP).

10. A method for using cloud access storage device, comprising:
collecting private data of a user of the cloud access storage device;
creating a home directory corresponding to the user in the cloud access storage device;
connecting the home directory to both the cloud and a local storage of a network terminal;
using the cloud storage access device to communicate with both the cloud and the local storage through the home directory; and
storing data to the cloud or the local storage, or accessing data stored in the cloud or the local storage through the home directory.

11. The method as claimed in claim 10, further comprising:
using the cloud and the local storage to communicate with each other through the home directory; and
using the cloud to process data stored in the local storage, and using appliances connected to the local storage to process data stored in the cloud.

12. The method as claimed in claim 10, wherein the home directory is connected to the local storage and the cloud by means of symbolic link.

13. The method as claimed in claim 10, further comprising:
creating at least two virtual holders under the home directory; and
connecting at least one of the virtual folders to the local storage and the other of the virtual folders to the cloud.

14. The method as claimed in claim 13, further comprising connecting each of the virtual folders to a real folder or a service routine of the cloud or the local storage to enable operations in the virtual folders to be applied to the cloud or the local storage.

15. The method as claimed in claim 10, further comprising allocating address of the home directory corresponding to the private data of the user.
